(19) United States
(12) Patent Application Publication
(10) Pub. No.: US 2007/0057498 A1
(43) Pub. Date: Mar. 15, 2007

(54) Airbag device

(75) Inventor: Min Seok Koh, Yongin-shi (KR)

Correspondence Address: GREENBLUM & BERNSTEIN, P.L.C., 1950 ROLAND CLARKE PLACE, RESTON, VA, 20191, US

(73) Assignee: Hyundai Mobis Co., Ltd., Yongin-shi (KR)

(21) Appl. No.: 11/305,089

(22) Filed: Dec. 19, 2005

(30) Foreign Application Priority Data
Sep. 12, 2005 (KR) 10-2005-0084842
Sep. 12, 2005 (KR) 10-2005-0084844

(51) Int. Cl. B60R 21/217; B60R 21/23

(52) U.S. Cl. 280/743.1; 280/728.2; 280/732

(57) ABSTRACT

An airbag device is disclosed. The airbag device comprises an airbag housing, an inflator connected to the airbag housing and capable of exerting an deployment force, a cushion assembly accommodated in the airbag housing and having a cushion deployable outside the airbag housing when the deployment force of the inflator is exerted thereon, and a pad mounted so as to cause friction with at least some parts of the cushion assembly. The eccentric deployment of the cushion is prevented, and the initial deployment force of the cushion is suppressed, thereby effectively coping with POF and OOP.

This Nonprovisional application claims priority under 35 U.S.C. § 119(a) on Patent Application No. 10-2005-84842 filed in Korea on Sep. 12, 2005, Patent Application No. 10-2005-84844 filed in Korea on Sep. 12, 2005, the entire contents of which are hereby incorporated by reference.

### BACKGROUND OF THE INVENTION

1. Field of the Invention

The present invention relates to an airbag device, and more particularly, to an airbag device which can control the unfolding of a cushion by using a frictional force by interposing a pad between the cushion and a cushion cover or interposing a pad between the cushion cover and an airbag housing.

2. Description of the Conventional Art

In general, an airbag device is mainly mounted on a vehicle in order to protect passengers in the vehicle in the event of an accident such as a vehicle crash or rollover.

As stated above, in the case of an airbag device being mounted on a vehicle, as illustrated in FIG. 1, there are a variety of types including, an airbag device 302 for a driver seat mounted on a steering wheel 301, an airbag device for a front passenger seat mounted on an instrument panel 303 in front of the front passenger seat and an airbag device for side collision mounted on a seat 105 or car body filler.

FIG. 2 is a sectional view showing an airbag device for a front passenger seat among various types of airbag devices to be mounted on a vehicle.

The airbag device as illustrated in FIG. 2 comprises an airbag housing 310 mounted to an instrument panel 303 opposite to a front passenger seat, a cushion 312 accommodated in the front part of the airbag housing 310 in a folding state, and an inflator 314 mounted to the rear part of the airbag housing 310 and exerting a high pressure gas type deployment force to the cushion 312 so that the cushion 312 can be deployed toward the front passenger seat in the event of a vehicle crash or rollover.

A cushion cover (not shown) for keeping the cushion 312 in a folded state is covered on the outer side of the cushion 312.

A retainer ring 113 for coupling the cushion 312 to the airbag housing 310 is disposed between the cushion 312 and the inflator 314.

The inflator 314 is controlled by a weight sensor or OC sensor being provided at a seat and capable of detecting if a passenger is out-of-position through the distribution of weight and pressure of a passenger occupying the seat.

The operation of the thus-constructed airbag device according to the conventional art will now be described.

When a crash occurs, a high pressure deployment gas is ejected from the inflator 314, and the high pressure deployment gas ejected from the inflator 314 is filled in the cushion 312.

Then, as the cushion 312 is filled with the high pressure inflating gas ejected from the inflator 314, it inflates like a balloon and is deployed toward the front passenger seat outside the airbag housing 310, thereby safely protecting the passenger occupying the front passenger seat.

However, the aforementioned airbag device according to the conventional art is problematic in that a part of the cushion 312 where the gas is concentrated is punched out before the gas is uniformly distributed in the cushion 312 at the time of initial deployment (this phenomenon is referred to as a punch-out force (POF) phenomenon), and moreover as the cushion is eccentrically deployed, the cushion 312 may threat a passenger or be deployed outside the area where the passenger can be protected.

Especially, in the case that the sitting posture of the passenger is not correct, that is, in an out-of-position (OOP) situation, there is a very high possibility that the passenger may be injured due to eccentric deployment of the cushion 4.

### SUMMARY OF THE INVENTION

The present invention is directed to solve the conventional art problems, and has for its object to provide an airbag device, which can prevent eccentric deployment of a cushion, prevent a POF by suppressing the initial deployment force of the cushion of a cushion assembly, and effectively cope with an OOP, by having a pad capable of causing friction with the cushion assembly and utilizing a frictional force caused by the pad.

Additionally, it is another object of the present invention to provide an airbag device, which can prevent eccentric deployment of a cushion, prevent a POF by suppressing the initial deployment force of the cushion of a cushion assembly, and effectively cope with an OOP, by forming rubber plates of a pad in multiple layers and utilizing a frictional force between the rubber plates of the pad as well as a frictional force between the pad and the cushion assembly.

To accomplish the above objects, there is provided an airbag device according to the present invention, comprising: an airbag housing; an inflator connected to the airbag housing and capable of exerting an deployment force; a cushion assembly accommodated in the airbag housing and having a cushion deployable outside the airbag housing when the deployment force of the inflator is exerted thereon; and a pad mounted so as to cause friction with at least some parts of the cushion assembly.

The cushion assembly consists of the cushion and a cushion cover covered so as to cover at least some parts of the cushion.

The pad is attached to an inner side of the cushion cover.

The pad is attached to the front side of the cushion accommodated in the airbag housing.

The pad is attached to an inner wall of the airbag housing.

The pad is attached to a side wall of the airbag housing.

The pad is made of rubber.

The pad is formed by laminating a plurality of rubber plates and connecting the adjacent rubber plates.

The pad is formed by laminating two rubber plates and connecting some parts of the two laminated rubber plates.

The airbag device is mounted on a vehicle, and some parts of the pad are interposed between the body of the vehicle where the airbag housing is mounted and the airbag housing.

Some parts of the pad are interposed between the cushion assembly and the airbag housing.

To accomplish the above objects, there is provided an airbag device according to the present invention, comprising: an airbag housing mounted to an instrument panel; an inflator connected to the airbag housing and capable of exerting an deployment force; a cushion accommodated in the airbag housing and deployable outside the airbag housing when the deployment force of the inflator is exerted thereon; a cushion cover covered on the outer side of the cushion; and a pad interposed between the cushion cover and the cushion.

The pad is attached to an inner side of the cushion cover.

The pad is attached to the front side of the cushion accommodated in the airbag housing. The pad is made of rubber.

The pad is formed by laminating a plurality of rubber plates and connecting the adjacent rubber plates.

To accomplish the above objects, there is provided an airbag device according to the present invention, comprising: an airbag housing mounted to an instrument panel; an inflator connected to the airbag housing and capable of exerting an deployment force; a cushion accommodated in the airbag housing and deployable outside the airbag housing when the deployment force of the inflator is exerted thereon; a cushion cover covered on the outer side of the cushion; and a pad interposed between the cushion cover and the airbag housing

The pad is attached to an inner side of the cushion cover.

The pad is made of rubber.

The pad is formed by laminating a plurality of rubber plates and connecting the adjacent rubber plates.

The airbag device according to the present invention can prevent eccentric deployment of a cushion, prevent a POF by suppressing the initial deployment force of the cushion of a cushion assembly, and effectively cope with an OOP, by having a pad capable of causing friction with the cushion assembly and utilizing a frictional force caused by the pad.

Additionally, the airbag device according to the present invention can prevent eccentric deployment of a cushion, prevent a POF by suppressing the initial deployment force of the cushion of a cushion assembly, and effectively cope with an OOP, by forming rubber plates of a pad in multiple layers and utilizing a frictional force between the rubber plates of the pad as well as a frictional force between the pad and the cushion assembly.

Additionally, the airbag device according to the present invention is not increased in volume and weight caused by the addition of the pad since the pad is formed of rubber.

Additionally, the airbag device according to the present invention is easy to perform tuning and design changes for the deployabiltiy of the cushion and for coping with an OOP by using the pad.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing a deployment state of a general airbag;

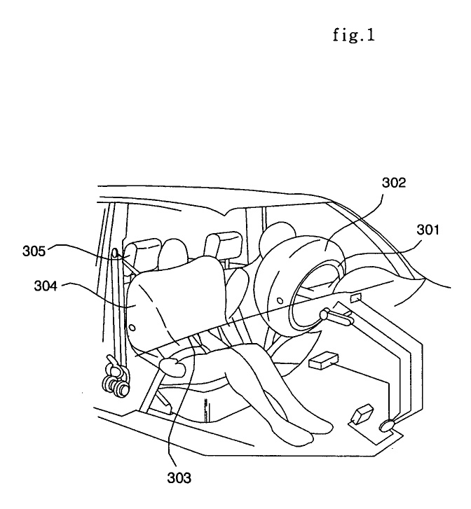

FIG. 2 is a sectional view of an airbag module according to the conventional art;

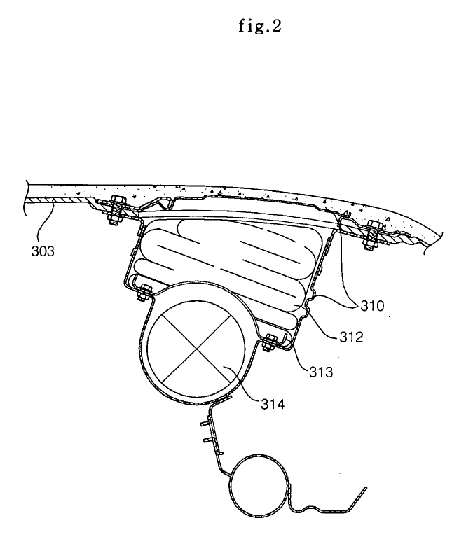

FIG. 3 is a sectional view of an airbag device according to a first embodiment of the present invention;

FIG. 4 is a block diagram of the initial stage of deployment of the airbag device according to the first embodiment of the present invention;

FIG. 5a is a schematic view showing three pads being attached to the left side of a cushion cover in a longitudinal direction according to the first embodiment of the present invention;

FIG. 5b is a schematic view showing three pads being attached to the left side of the cushion cover in a lateral direction according to the first embodiment of the present invention;

FIG. 5c is a schematic view showing one pad being attached to the left side of the cushion cover in a longitudinal direction according to the first embodiment of the present invention;

FIG. 5d is a schematic view showing three pads being attached to the right side of the cushion cover in a longitudinal direction according to the first embodiment of the present invention;

FIG. 5e is a schematic view showing three pads being attached to the right side of the cushion cover in a lateral direction according to the first embodiment of the present invention;

FIG. 5f is a schematic view showing one pad being attached to the right side of the cushion cover in a longitudinal direction according to the first embodiment of the present invention;

FIG. 6a is a schematic view showing the cushion before a deployment gas is introduced thereinto according to the first embodiment of the present invention;

FIG. 6b is a schematic view showing the cushion when a deployment gas starts to be introduced thereinto to tear the tear line of the cushion cover according to the first embodiment of the present invention;

FIG. 6c is a schematic view showing the cushion when a deployment gas is introduced to inflate the cushion according to the first embodiment of the present invention;

FIG. 7 is a sectional view of an airbag device according to a second embodiment of the present invention;

FIG. 8a is a schematic view showing a pad being mounted to the left side of the airbag device according to the second embodiment of the present invention;

FIG. 8b is a schematic view showing the pad being mounted to the right side of the airbag device according to the second embodiment of the present invention;

FIG. 9 is a sectional view of an airbag device according to the present invention;

FIG. 10a is a schematic view showing a pad being mounted to the left side of the airbag device according to the third embodiment of the present invention;

FIG. 10b is a schematic view showing the pad being mounted to the right side of the airbag device according to the third embodiment of the present invention;

### DETAILED DESCRIPTION OF THE PREFERRED EMBODIMENTS

Hereinafter, embodiments of an airbag device according to the present invention will be described with reference to the accompanying drawings.

There may exist a plurality of embodiments of the airbag device according to the present invention, and hereinafter, the most preferred embodiments will now be described. The basic structure of the airbag device is the same as that of the conventional art, so a detailed description thereof will be omitted.

Hereinafter, a first embodiment of an airbag device according to the present invention will be described in detail with reference to the accompanying drawings.

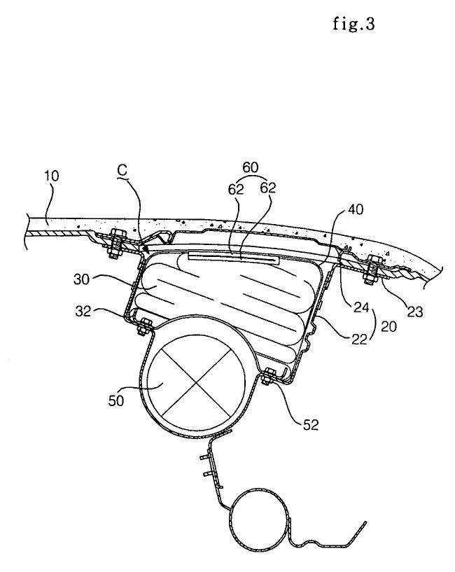

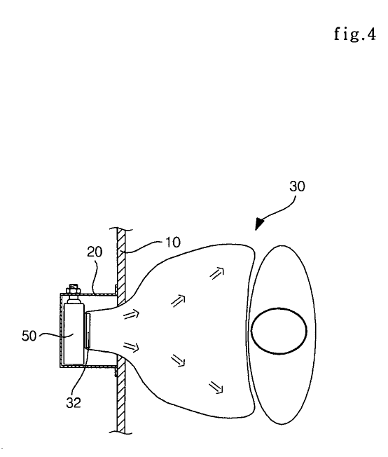

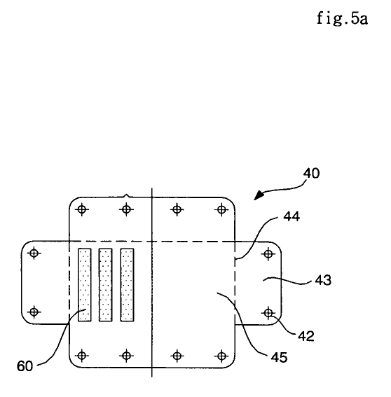

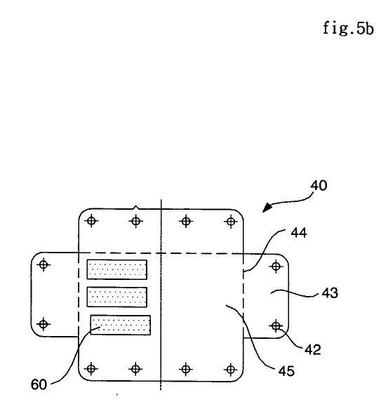

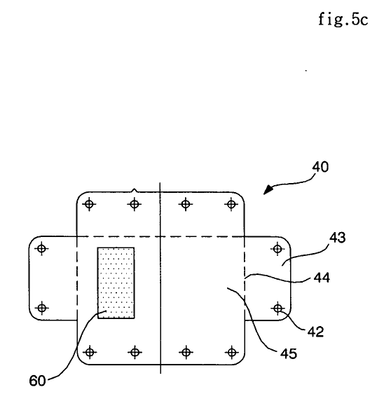

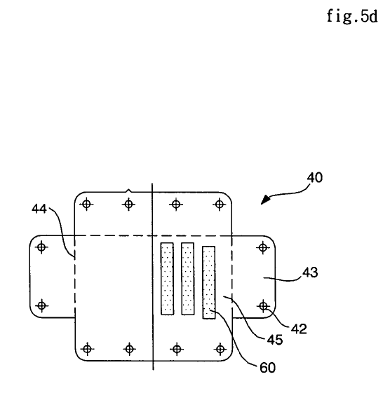

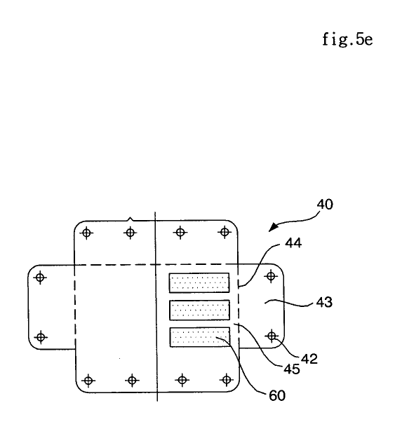

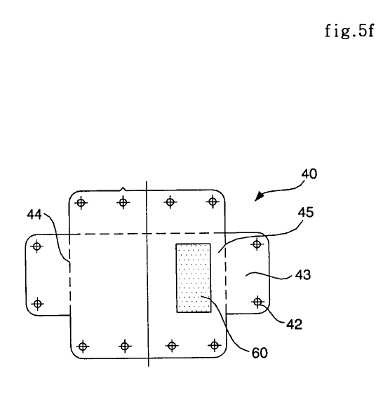

FIG. 3 is a sectional view of an airbag device according to a first embodiment of the present invention. FIG. 4 is a block diagram of the initial stage of deployment of the airbag device according to the first embodiment of the present invention. FIG. 5a is a schematic view showing three pads being attached to the left side of a cushion cover in a longitudinal direction according to the first embodiment of the present invention.

The airbag device according to the first embodiment of the present invention is for use in a front passenger seat that is mounted to an instrument panel 10 for protecting a front passenger, and comprises: an airbag housing 20 mounted to the instrument panel 10 at the front passenger seat side opposite to the front passenger seat, a cushion assembly C accommodated in the front part of the airbag housing 20, an inflator 50 mounted in the airbag housing 20 and capable of exerting a deployment force to the cushion assembly C in the event of a crash, and a pad 60 capable of causing friction with at least some parts of the cushion assembly 30.

The airbag housing 20 consists of an airbag case 22 whose front side is opened and an airbag door 24 mounted to the instrument panel 10 and capable of opening and closing the front side of the airbag case 22.

The airbag case 22 is provided at an outer front part with an upper bracket 23 coupled to the instrument panel 10.

A tear line (not shown) may be formed on the airbag door 24 so that it can be torn by the development force of the cushion 30 without being removed from the instrument panel 10 when the cushion 30 is deployed.

The cushion assembly C is connected to the inflator 50 so that it can receive the deployment force of the inflator 50, and includes a cushion 30 accommodated in the airbag housing 20, being folded in a predetermined form.

The cushion 30 is opened at the rear end whose surface contacts the inflator 50 so as to receive the deployment force of the inflator 50.

This open rear end of the cushion 30 is coupled to the airbag housing 20 through a retainer ring 32 disposed between the cushion assembly C and the inflator 50.

The retainer ring 32 is fixed to the airbag housing 20 through a drive-in bolt 52 along with the cushion 30.

The cushion assembly C further includes a cushion cover 40 covered on the outer side of the cushion 50 so as to surround at least some parts of the cushion 50 and keeping the cushion in a folded shape.

The cushion cover 40 has a flange portion 43 interposed between the retainer ring 32 and the airbag housing 20 and formed with a through hole 42 for passing the drive-in bolt 52 so that I can be fixed to the airbag housing 20 by the drive-in bolt 52.

The cushion cover 40 has a tear line 44 formed at one side of a cover portion 45 surrounding the cushion 30 so that it can be torn when the cushion 30 is deployed to a predetermined volume upon receipt of the deployment force of the inflator 50.

The tear line 44 of the cushion cover 40 is torn when a deployment gas is introduced into the cushion 30 to inflate the cushion cover 40 to a predetermined volume, and thus it can be substituted with a sewing line capable of carrying out this function. Hereinafter, a description will be made only with respect to the tear line.

The pad 60 is for improving the OOP (out of position) and POF (punch out force) functions and preventing the eccentric deployment of the cushion 30 by suppressing the initial deployment of the cushion 30 by a frictional force when the cushion 30 is deployed upon receipt of the deployment force of the inflator 50.

The pad 60 is preferably made of rubber for giving a proper frictional force thereto and being lightweight and slim.

Such a pad 60 may be disposed between the cushion 30 and the cushion cover 40 and attached to an inner side of the cushion cover 40 so that the cushion 30 can suppress the deployment of the cushion 30 before tearing the cushion cover 40 in the event of deployment of the cushion 30.

A plurality of rubber plates 62 is laminated to the pad 60 so as to weaken the initial deployment force of the cushion 30 by using the frictional force between the rubber plates 62, and one ends thereof are interconnected. This is to cope with the OOP by effectively weakening the initial deployment force of the cushion 30 by additionally using the frictional force between the rubber plates 62 as well as the frictional force between the pad 60 and the cushion cover 40.

Such a pad 60 can be designed by freely selecting the shape and attachment position thereof according to the deployment direction of the cushion 30, as shown in FIGS. 5a to 5f, and it is needless to say that it can be designed with the optimality in number thereof according to the initial deployment force of the cushion 30.

As described above, the pad 60 is made of a plurality of rubber plates, and hereinafter a description will be made only with respect to the one laminated with two rubber plates.

The operation of the present invention thus constructed will now be described.

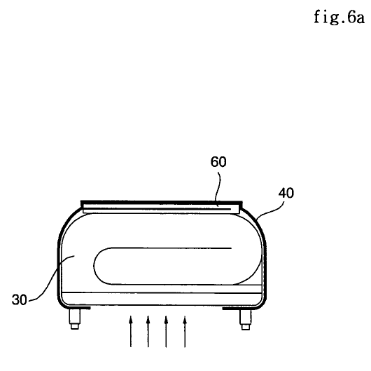

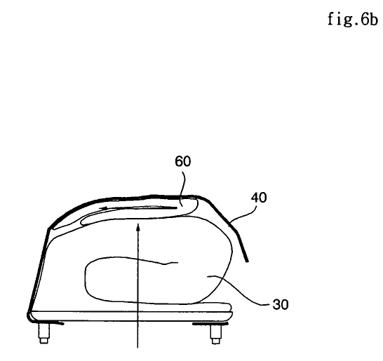

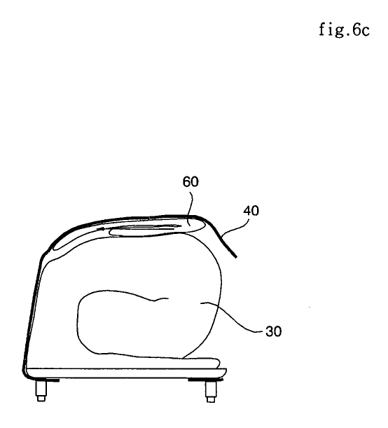

FIG. 6a is a schematic view showing the cushion before a deployment gas is introduced thereinto according to the first embodiment of the present invention. FIG. 6b is a schematic view showing the cushion when a deployment gas starts to be introduced thereinto to tear the tear line of the cushion cover according to the first embodiment of the present invention. FIG. 6c is a schematic view showing the cushion when a deployment gas is introduced to inflate the cushion according to the first embodiment of the present invention.

When a car crash occurs, a high pressure deployment gas is ejected from the inflator 50. The high pressure deployment gas ejected from the inflator 50 is filled in the cushion 30, and the cushion 30 inflates like a balloon.

At this point, as illustrated in FIGS. 6a to 6c, the tear line 44 formed on the cushion cover 40 is maintained as it is without being torn before the deployment gas is introduced into the cushion, while when the deployment gas is introduced into the cushion 30 to inflate the cushion 30 to a predetermined volume, the tear line 44 is torn.

At the same time, a frictional force is exerted to the rubber plates at upper and lower parts of the pad 60, and a frictional force is also exerted between the cushion cover 40 and the pad 60, thereby weakening the initial deployment force of the cushion.

By the above operation, the airbag device is able to prevent the eccentricity of the cushion 30 and improve the OOP and POF functions by effectively controlling the initial deployment force of the cushion 30. Further, the deployment direction of the cushion 30 can be determined by the pad 60, i.e., some parts of the cushion, being relatively delayed in deployment in comparison with other regions of the cushion 30.

Hereinafter, a second embodiment of an airbag device according to the present invention will be described in detail with reference to the accompanying drawings.

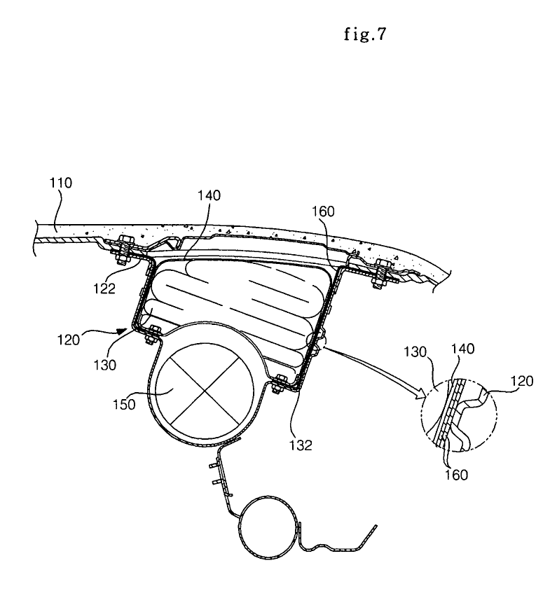

FIG. 7 is a sectional view of an airbag device according to a second embodiment of the present invention.

The airbag device according to the second embodiment of the present invention is for use in a front passenger seat that is mounted to an instrument panel 110 for protecting a front passenger, and comprises: an airbag housing 120 mounted to the instrument panel 110 at the front passenger seat side opposite to the front passenger seat, a cushion 130 accommodated in the front part of the airbag housing 120 and fixed to the airbag housing 120 through a retainer ring 132, a cushion cover 140 covered on the outer side of the cushion 130 so as to surround at least some parts of the cushion 130, an inflator 150 mounted in the airbag housing 120 and capable of exerting a deployment force to the cushion 130 in the event of a crash, and a pad 160 capable of causing friction with at least some parts of the cushion assembly 30.

The airbag housing 152 is provided with an upper bracket 152 for coupling to the instrument panel 110.

The pad 160 is preferably made of rubber for giving a proper frictional force thereto and being lightweight and slim.

The pad 160 may be disposed between a side wall of the airbag housing 120 surface-contacting the cushion cover 140 and the cushion cover 140 so that it can cause friction with the cushion 130 through the cushion cover 140 when the cushion 130 is deployed.

Moreover, some parts of the pad 160 may be interposed between the upper bracket 122 of the airbag housing 120 and the instrument panel 110 so that it can be fixed to the airbag housing 120.

Moreover, some parts of the pad 160 may be interposed between the airbag housing 120 and the retainer ring 132 so that it can be fixed to the airbag housing 120 along with the cushion 130 and the cushion cover 140.

A plurality of rubber plates is laminated to the pad 160 so as to additionally use the frictional force between the rubber plates as well as the frictional force between the pad 160 and the cushion cover 140 and the frictional force between the pad 160 and the airbag housing 120, and one ends thereof are interconnected.

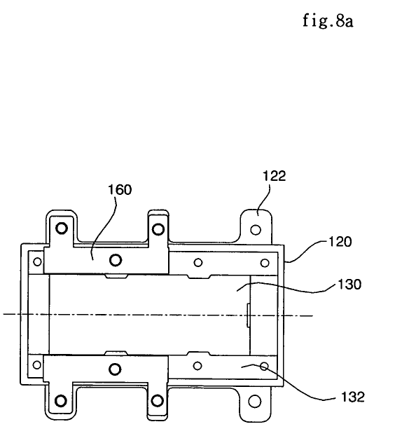

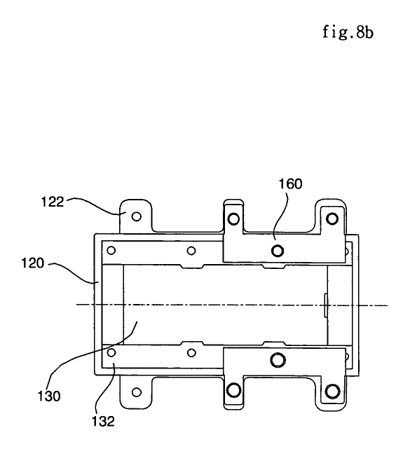

Such a pad 160 can be designed by freely selecting the shape and attachment position thereof according to the deployment direction of the cushion 130 as shown in FIGS. 8a to 8f.

That is to say, FIG. 8a is a schematic view showing a pad being mounted to the left side of the airbag device according to the second embodiment, in which the eccentricity of the cushion 130 is prevented, the initial deployment force of the cushion 130 is suppressed, and further, the cushion 130 can be induced to be deployed to the right due to the pad 160 disposed at the left side of the airbag housing 120.

FIG. 8b is a schematic view showing the pad being mounted to the right side of the airbag device according to the second embodiment, in which the eccentricity of the cushion 130 is prevented, the initial deployment force of the cushion 130 is suppressed, and further, the cushion 130 can be induced to be deployed to the left due to the pad 160 disposed at the left side of the airbag housing 120.

The operation of the thus-constructed airbag device according to the second embodiment of the present invention will now be described.

At an initial stage of deployment during which the cushion 130 starts to inflate in the event of deployment of the cushion 130, the deployment force of the cushion 130 is suppressed by a frictional force caused by the pad 160. Especially, the deployment of the cushion 130 is suppressed relatively much at a position where the pad 160 is attached.

Further, the deployment direction of the cushion 130 can be determined by the pad 160, i.e., some parts of the cushion 130, being relatively delayed in deployment in comparison with other regions of the cushion 130.

The second embodiment of the present invention is identical to the first embodiment of the present invention except for the above-mentioned construction and operation.

Hereinafter, an airbag device according to a third embodiment of the present invention will be described in detail with reference to the accompanying drawings.

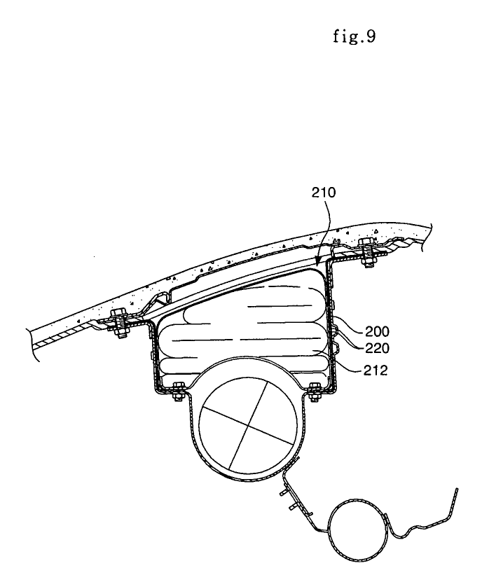

FIG. 9 is a sectional view of an airbag device according to the present invention.

In the airbag device according to the third embodiment of the present invention, a pad 220 capable of causing friction with a cushion assembly 210 at the initial deployment of a cushion 212 of the cushion assembly 210 is mounted between a side wall of an airbag housing 200 and the cushion assembly 210.

The pad 220 is attached to an inner wall of the airbag housing 200, and interposed between the airbag housing 210 and an instrument panel 200 to thus be fixed to the airbag housing 200.

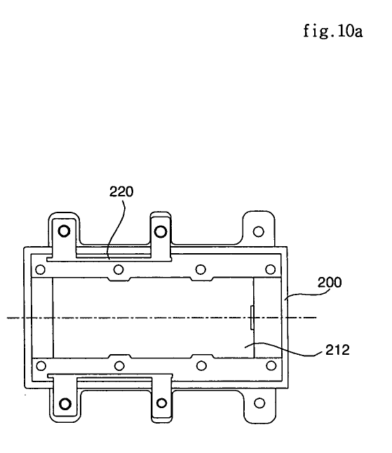

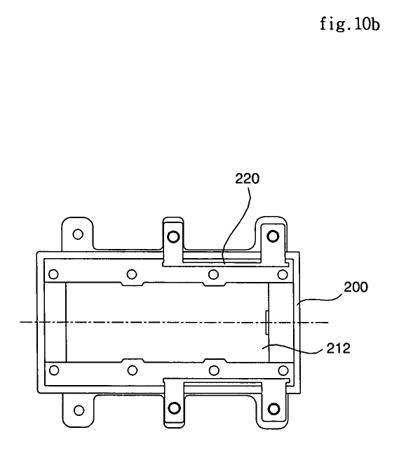

Such a pad 220 is changeable in its mounting position as shown in FIGS. 10a and 10b.

The airbag device according to the third embodiment of the present invention is identical to the first or second embodiment of the present invention, so a further detailed description thereof will be omitted.

While this specification has been described only with respect to an airbag device for a front passenger seat, it is natural that the technique provided by folding some parts of the cushion and sewing the folded region, which is the technical idea of the present invention, is also easily applicable to airbag devices for a driver seat and for side collision so as to improve OOP and POF functions.

The effects of the airbag device according to the present invention will be described in detail.

The airbag device according to the present invention can prevent eccentric deployment of a cushion, prevent a POF by suppressing the initial deployment force of the cushion of a cushion assembly, and effectively cope with an OOP, by having a pad capable of causing friction with the cushion assembly and utilizing a frictional force caused by the pad.

Additionally, the airbag device according to the present invention can prevent eccentric deployment of a cushion, prevent a POF by suppressing the initial deployment force of the cushion of a cushion assembly, and effectively cope with an OOP, by forming rubber plates of a pad in multiple layers and utilizing a frictional force between the rubber plates of the pad as well as a frictional force between the pad and the cushion assembly.

Additionally, the airbag device according to the present invention is not increased in volume and weight caused by the addition of the pad since the pad is formed of rubber.

Additionally, the airbag device according to the present invention is easy to perform tuning and design changes for the deployability of the cushion and for coping with an OOP by using the pad.

What is claimed is:

1. An airbag device, comprising:
an airbag housing;
an inflator connected to the airbag housing and capable of exerting an deployment force;
a cushion assembly accommodated in the airbag housing and having a cushion deployable outside the airbag housing when the deployment force of the inflator is exerted thereon; and
a pad mounted so as to cause friction with at least some parts of the cushion assembly.

2. The airbag device of claim 1, wherein the cushion assembly consists of the cushion and a cushion cover covered so as to cover at least some parts of the cushion.

3. The airbag device of claim 1, wherein the pad is attached to an inner side of the cushion cover.

4. The airbag device of claim 1, wherein the pad is attached to the front side of the cushion accommodated in the airbag housing.

5. The airbag device of claim 1, wherein the pad is attached to an inner wall of the airbag housing.

6. The airbag device of claim 5, wherein the pad is attached to a side wall of the airbag housing.

7. The airbag device of claim 1, wherein the pad is made of rubber.

8. The airbag device of claim 1, wherein the pad is formed by laminating a plurality of rubber plates and connecting the adjacent rubber plates.

9. The airbag device of claim 1, wherein the pad is formed by laminating two rubber plates and connecting some parts of the two laminated rubber plates.

10. The airbag device of claim 1, wherein the airbag device is mounted on a vehicle, and some parts of the pad are interposed between the body of the vehicle where the airbag housing is mounted and the airbag housing.

11. The airbag device of claim 1, wherein some parts of the pad are interposed between the cushion assembly and the airbag housing.

12. An airbag device, comprising:
an airbag housing mounted to an instrument panel;
an inflator connected to the airbag housing and capable of exerting an deployment force;
a cushion accommodated in the airbag housing and deployable outside the airbag housing when the deployment force of the inflator is exerted thereon;
a cushion cover covered on the outer side of the cushion; and
a pad interposed between the cushion cover and the cushion.

13. The airbag device of claim 12, wherein the pad is attached to an inner side of the cushion cover.

14. The airbag device of claim 13, wherein the pad is attached to the front side of the cushion accommodated in the airbag housing.

15. The airbag device of claim 13, wherein the pad is made of rubber.

16. The airbag device of claim 13, wherein the pad is formed by laminating a plurality of rubber plates and connecting the adjacent rubber plates.

17. An airbag device, comprising:
an airbag housing mounted to an instrument panel;
an inflator connected to the airbag housing and capable of exerting an deployment force;
a cushion accommodated in the airbag housing and deployable outside the airbag housing when the deployment force of the inflator is exerted thereon;
a cushion cover covered on the outer side of the cushion; and
a pad interposed between the cushion cover and the airbag housing

18. The airbag device of claim 17, wherein the pad is attached to an inner side of the cushion cover.

19. The airbag device of claim 17, wherein the pad is made of rubber.

20. The airbag device of claim 17, wherein the pad is formed by laminating a plurality of rubber plates and connecting the adjacent rubber plates.
